(19) United States
(12) Patent Application Publication
(10) Pub. No.: US 2025/0065748 A1
(43) Pub. Date: Feb. 27, 2025

(54) CHARGE CONTROL DEVICE

(71) Applicant: Isuzu Motors Limited, Kanagawa (JP)

(72) Inventor: Takuya KIKUCHI, Fujisawa-shi, Kanagawa (JP)

(73) Assignee: Isuzu Motors Limited, Kanagawa (JP)

(21) Appl. No.: 18/726,802

(22) PCT Filed: Oct. 17, 2022
(86) PCT No.: PCT/JP2022/038588

§ 371 Date: Jul. 4, 2024

(30) Foreign Application Priority Data
Jan. 7, 2022 (JP) 2022-001630

(51) Int. Cl. B60L 53/62; B60L 58/18; H02J 7/00

(52) U.S. Cl. CPC B60L 53/62; B60L 58/18; H02J 7/0047; H02J 7/007182

(57) ABSTRACT

Provided is a charge control device with which the charge amount of a battery is easily raised. This charge control device comprises: a connection unit for connecting a plurality of batteries in parallel to a charger connected to a vehicle; an acquisition unit for acquiring the voltage of the plurality of batteries; and a control unit for calculating a difference in potential between a connected battery that is connected to the charger and an unconnected battery that is not connected to the charger, among the plurality of batteries, on the basis of the voltage acquired by the acquisition unit and controlling the connection unit so as to furthermore connect the unconnected battery to the charger when the difference in potential is not within a prescribed potential range.

### TECHNICAL FIELD

The present disclosure relates to a charging control apparatus.

### BACKGROUND ART

Conventionally, a charging control apparatus has been put into practical use which controls connected states of a plurality of batteries to a charger when the charger is connected to a vehicle. The charging control apparatus can control the connected states of the plurality of batteries by, for example, switching a switch connecting between the charger and the plurality of batteries. At this time, the charging control apparatus is required to control the connected states such that charging amounts of the batteries are increased.

Therefore, as a technique for increasing charging amounts of batteries, PTL 1 discloses a battery charging apparatus that charges batteries in a short time so that charging amounts of the batteries are not uneven, for example. When a main battery of this apparatus is in a deep discharge state, the apparatus increases a charging ratio on a main-battery side and thus increases a charging amount of the main battery, whereas, as the discharge state of the main battery becomes shallow, the apparatus increases a charging ratio on a sub-battery side and thus increases a charging amount of a sub battery. The charging amounts of the batteries can be thereby increased.

### CITATION LIST

### Patent Literature

### PTL 1

Japanese Patent Application Laid-Open No. H06-209532

### SUMMARY OF INVENTION

### Technical Problem

However, since the apparatus of PTL 1 performs charging while switching the batteries, it is difficult to perform charging with ease.

An object of the present disclosure is to provide a charging control apparatus capable of easily increasing a charging amount of a battery.

### Solution to Problem

A charging control apparatus according to the present disclosure includes: a connection section that connects a plurality of batteries in parallel to a charger connected to a vehicle; an acquisition section that acquires voltages of the plurality of batteries; and a control section that calculates, based on the voltages acquired by the acquisition section, a potential difference between a connected battery and an unconnected battery among the plurality of batteries and, in a case where the potential difference falls within a predetermined potential range, that controls the connection section such that the unconnected battery is connected to the charger, the connected battery being connected to the charger, the unconnected battery not being connected to the charger.

### Advantageous Effects of Invention

According to the present disclosure, a charging amount of a battery can be easily increased.

### BRIEF DESCRIPTION OF DRAWINGS

FIG. 1 illustrates a configuration of a vehicle equipped with a charging control apparatus according to Embodiment 1 of the present disclosure;

FIG. 2 is a diagram for indicating a state in which selected batteries are connected to a charger;

FIG. 3 is a diagram for indicating a state in which unselected batteries are connected to the charger;

FIG. 4 is a diagram for indicating a state in which batteries are charged to full capacities thereof;

FIG. 5 is a diagram for indicating a state of searching for a battery whose potential difference with a reference battery falls within a predetermined potential range in Embodiment 2;

FIG. 6 is a diagram for indicating a state in which batteries are connected to a charger in Embodiment 2; and

FIG. 7 is a diagram for indicating a state in which the batteries are charged to full capacities thereof in Embodiment 2.

### DESCRIPTION OF EMBODIMENTS

Hereinafter, an embodiment of the present disclosure will be described with reference to the accompanying drawings.

### Embodiment 1

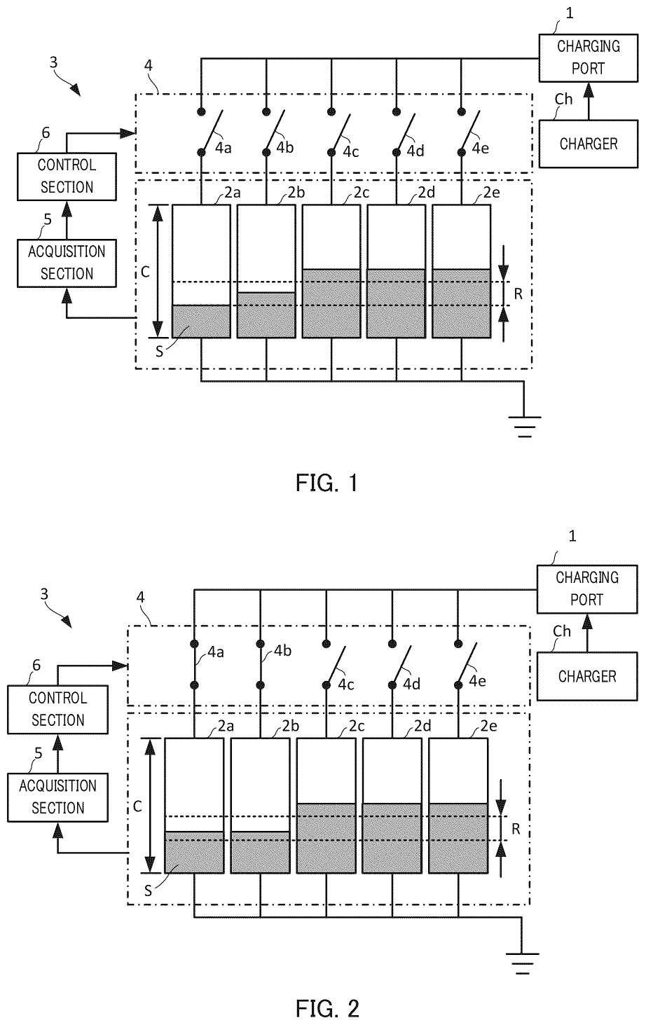

FIG. 1 illustrates a configuration of a vehicle equipped with a charging control apparatus according to Embodiment 1 of the present disclosure. This vehicle includes charging port 1, a plurality of batteries 2a to 2e, and charging control apparatus 3. Note that the vehicle is configured of, for example, an electrically powered vehicle such as an electric vehicle and a hybrid vehicle. Further, an example of the vehicle includes a commercial vehicle such as a truck.

Charging port 1 is for inputting power supplied from charger Ch and is provided to allow connection of charger Ch. Charging port 1 is connected to batteries 2a to 2e, and power from charger Ch is supplied to batteries 2a to 2e through charging port 1.

Incidentally, charger Ch is to be provided outside a charging station, an example of which includes a normal charger, a rapid charger, and the like.

Batteries 2a to 2e each have a predetermined capacity C and charge the power supplied from charger Ch. Examples of batteries 2a to 2e include, for example, lithium-ion batteries, nickel-metal hydride batteries, and the like.

Charging control apparatus 3 includes connection section 4, acquisition section 5, and control section 6. Control section 6 is connected to each of batteries 2a to 2e through acquisition section 5, and connection section 4 is connected to this control section 6.

Connection section 4 connects batteries 2a to 2e in parallel to charger Ch that is connected to charging port 1. Here, connection section 4 includes switches 4a to 4e arranged corresponding respectively to batteries 2a to 2e. These switches 4a to 4e are for switching to connected states or disconnected states between batteries 2a to 2e and charger Ch, and the number of batteries 2a to 2e to be connected in parallel varies in accordance with the switching by switches 4a to 4e. Switches 4a to 4e can be configured of, for example, relay switches and the like.

Acquisition section 5 is for acquiring voltages of batteries 2a to 2e and can be configured of, for example, a voltage meter. Acquisition section 5 measures voltages of respective batteries 2a to 2e and outputs the measured voltages to control section 6.

When charger Ch is connected, control section 6 calculates, based on the voltages acquired by acquisition section 5, potential differences between batteries 2a to 2e and then controls connection section 4 such that batteries 2a and 2b between which the potential difference falls within predetermined potential range R are connected to charger Ch. That is, control section 6 controls connection section 4 such that switches 4a and 4b are in connected states.

At this time, control section 6 selects battery 2a having the least storage amount S or the lowest voltage as a reference battery when charger Ch is connected, and then controls connection section 4 such that this reference battery 2a and battery 2b whose potential difference with reference battery 2a falls within predetermined potential range R are connected to charger Ch.

In addition, control section 6 calculates, based on the voltages of batteries 2a to 2e acquired by acquisition section 5, a potential difference between connected batteries 2a and 2b among batteries 2a to 2e, which are connected to charger Ch, and unconnected batteries 2c to 2e among batteries 2a to 2e, which are not connected to charger Ch. Then, when the potential difference between connected batteries 2a and 2b and unconnected batteries 2c to 2e falls within predetermined potential range R, control section 6 controls connection section 4 such that unconnected batteries 2c to 2e are further connected to charger Ch. That is, control section 6 controls connection section 4 such that switches 4c to 4e are in connected states.

Here, predetermined potential range R can be set based on, for example, an allowable voltage of control apparatus 3 (voltage acceptable to maintain function of charging control apparatus 3), e.g., based on allowable voltages of switches 4a to 4d. Further, batteries 2a to 2e and charging control apparatus 3 can be integrally configured. For example, each of batteries 2a to 2e may be configured as a battery pack, and charging control apparatus 3 may be installed in the battery pack.

Functions of charging control apparatus 3 can be realized also by a computer program. For example, a reading apparatus of a computer reads programs for implementing functions of control apparatus 3 from a recording medium that stores the programs, and stores the programs in a storage apparatus. A Central Processing Unit (CPU) then copies the programs stored in the storage apparatus to a Random Access Memory (RAM) and sequentially reads outs, from the RAM, and executes instructions included in the programs, thereby realizing the functions of charging control apparatus 3.

Next, an operation of the present embodiment will be described.

First, as illustrated in FIG. 1, when a power source of the vehicle is turned to an OFF state, e.g., a key is turned to an OFF state by a vehicle operation section (not illustrated), connection section 4 turns switches 4a to 4e to the disconnected states and waits.

Subsequently, when charger Ch is connected to charging port 1, control section 6 receives a connection signal from charging port 1 indicating that charger Ch has been connected and then calculates potential differences between batteries 2a to 2e, based on voltages measured by acquisition section 5. Control section 6 then selects batteries 2a and 2b between which the potential difference falls within predetermined potential range R. At this time, control section 6 determines storage amounts S of batteries 2a to 2e, based on the voltages measured by acquisition section 5, and selects battery 2a having the least storage amount S. Note that control section 6 may select reference battery 2a having the lowest voltage, based on the voltages measured by acquisition section 5. For example, control section 6 can select reference battery 2a by calculating storage amounts S of batteries 2a to 2e based on the voltages measured by acquisition section 5. Furthermore, control section 6 calculates, based on the voltage of reference battery 2a, potential differences between reference battery 2a and batteries 2b to 2e and then selects battery 2b whose potential difference with reference battery 2a falls within predetermined potential range R.

As illustrated in FIG. 2, control section 6 controls connection section 4 such that selected reference battery 2a and battery 2b are connected to charger Ch and thus switches switches 4a and 4b from the disconnected states to the connected states. As a result, a current flows between battery 2a and battery 2b, which makes storage amount S constant. At this time, connection of batteries 2c to 2e whose potential differences with battery 2a are larger than predetermined potential range R may cause a failure due to an instantaneous large current-flow in charging control apparatus 3. For example, a large current may flow in switches 4a and 4c to 4e connecting between battery 2a and 2c to 2e, causing a failure such as welding of contact points.

Thus, in the present disclosure, control section 6 controls connection section 4 such that batteries 2a and 2b between which the potential difference falls within predetermined potential range R are connected to charger Ch. This makes it possible to suppress a large current-flow in charging control apparatus 3 and thus prevent malfunction of charging control apparatus 3.

Further, arrangement of switches 4a to 4e corresponding respectively to batteries 2a to 2e enables easy switching between connection and disconnection of batteries 2a to 2e.

In this manner described above, when switches 4a and 4b are switched to the connected states, power supply from charger Ch is started, and the power is thus supplied to connected batteries 2a and 2b that are connected to charger Ch. This increases storage amounts S of connected batteries 2a and 2b in accordance with a charging amount from charger Ch.

At this time, acquisition section 5 sequentially measures voltages of batteries 2a to 2e, and control section 6 determines, based on the voltages measured by acquisition section 5, whether a potential difference between connected batteries 2a and 2b and unconnected batteries 2c to 2e falls within predetermined potential range R. When the potential difference connected batteries 2a and 2b and unconnected batteries 2c to 2e is out of predetermined potential range R, control section 6 maintains the present connected state, i.e., a state where only connected batteries 2a and 2b are connected to charger Ch.

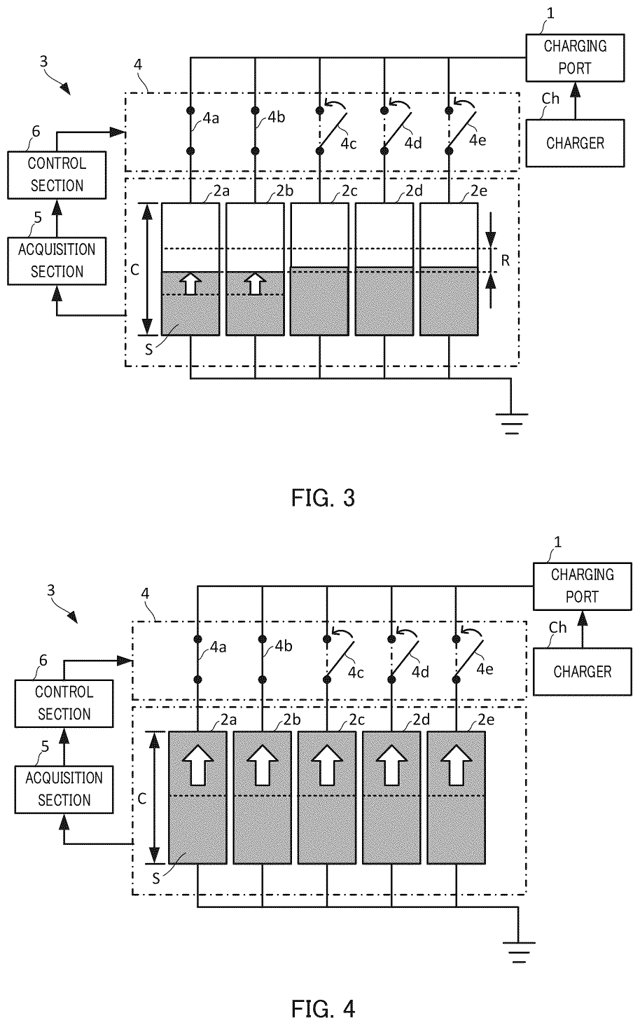

On the other hand, as illustrated in FIG. 3, control section 6 controls connection section 4 such that unconnected batteries 2c to 2e are further connected to charger Ch, in addition to connected batteries 2a and 2b, when a potential difference between connected batteries 2a and 2b and unconnected batteries 2c to 2e falls within predetermined potential range R. That is, control section 6 controls connection section 4 such that switches 4c to 4e are further connected while keeping switches 4a and 4b connected.

In the manner described above, unconnected batteries 2c to 2e are connected to batteries 2a and 2b when the potential difference between connected batteries 2a and 2b and unconnected batteries 2c to 2e falls within predetermined potential range R, thereby making it possible to suppress a large current-flow in charging control apparatus 3 and thus prevent malfunction of charging control apparatus 3. At this time, control section 6 preferably connects unconnected batteries 2c to 2e to charger Ch at the timing when the potential difference between connected to batteries 2a and 2b and unconnected batteries 2c to 2e becomes substantially the same value. This makes it possible to surely prevent malfunction of charging control apparatus 3.

When batteries 2a to 2e are thus connected to charger Ch, batteries 2c to 2e are also supplied with power from charger Ch, and storage amount S is increased to full capacity C of each of batteries 2a to 2e, as illustrated in FIG. 4.

In this manner described above, when the potential difference between connected batteries 2a and 2b and unconnected batteries 2c to 2e falls within predetermined potential range R, further connecting unconnected batteries 2c to 2e to charger Ch makes it possible to easily maximize charging amounts of batteries 2a to 2e while suppressing malfunction of charging control apparatus 3.

Further, since batteries 2a to 2e are sequentially connected and charged, it is possible to suppress an extreme frequent connection of a particular battery and thus suppress uneven deterioration among batteries 2a to 2e.

Further, control section 6 selects battery 2a having the least storage amount S or the lowest voltage as a reference battery when charger Ch is connected to charging port 1, and then controls connection section 4 such that reference battery 2a and battery 2b whose potential difference with reference battery 2a falls within predetermined potential range R are connected to charger Ch. This enables charging of all batteries 2a to 2e, thereby making it possible to further maximize charging amounts of batteries 2a to 2e while suppressing malfunction of control apparatus 3.

According to the present embodiment, when a potential difference between connected batteries 2a and 2b and unconnected batteries 2c to 2e falls within predetermined potential range R, control section 6 controls connection section 4 such that unconnected batteries 2c to 2e are further connected to charger Ch Thus, charging amounts of batteries 2a to 2e can be easily increased.

### Embodiment 2

In the following, Embodiment 2 of the present disclosure will be described. Here, differences with Embodiment 1 will be mainly described, and same reference numerals will be used for parts the same as in Embodiment 1, and detailed description thereof will be omitted.

In the above-described Embodiment 1, when charger Ch is connected, control section 6 selects reference battery 2a having the least storage amount or the lowest voltage and connects the selected battery to charger Ch, but the present disclosure is not limited to this as long as a predetermined battery is connected to charger Ch.

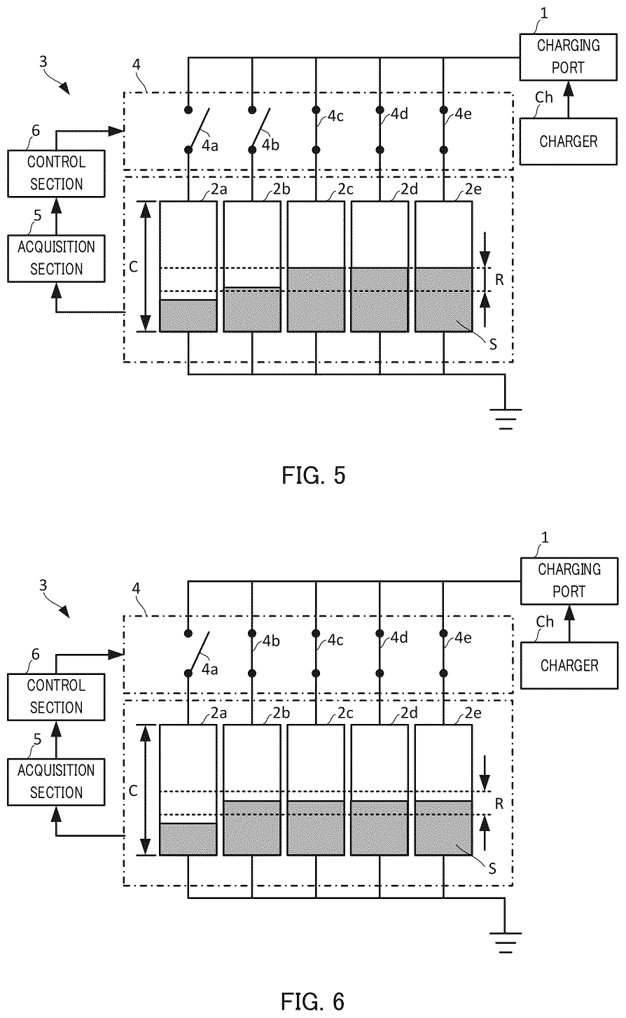

For example, as illustrated in FIG. 5, in a situation where a power source of a vehicle is in an ON state when charger Ch is connected, control section 6 can control connection section 4 such that reference batteries 2c to 2e, which are connected to a load of the vehicle, and battery 2b whose potential difference with reference batteries 2c to 2e falls within predetermined potential range R are connected to charger Ch.

Here, for example, it is assumed that, at the time before charger Ch is connected, the vehicle is driven with batteries 2c to 2e connected, via connection section 4, to a load such as a motor and an air conditioner. Charger Ch is then connected to charging port 1 while the power source of the vehicle is in the ON state, e.g., a key is in an ON state in a vehicle operation section (not illustrated). Thus, in a situation where the power source of the vehicle is in the ON state when charger Ch is connected, control section 6 detects reference batteries 2c to 2e that are connected to the load of the vehicle via connection section 4 and searches for battery 2b whose potential difference with reference batteries 2c to 2e falls within predetermined potential range R.

Next, as illustrated in FIG. 6, control section 6 controls connection section 4 such that reference batteries 2c to 2e and battery 2b are connected to charger Ch. That is, control section 6 switches switch 4b from a disconnected state to a connected state while keeping switches 4c to 4e connected. As a result, a current flows between batteries 2c to 2e and battery 2b, which makes storage amount S constant.

At this time, control section 6 controls connection section 4 such that battery 2b whose potential difference with reference batteries 2c to 2e falls within predetermined potential range R is connected to charger Ch. This makes it possible to suppress a large current-flow in charging control apparatus 3 and thus prevent malfunction of charging control apparatus 3.

Further, since reference batteries 2c to 2e are kept connected before and after start of charging, power supply from reference batteries 2c to 2e to the load can be maintained, thereby suppressing stop of a function of the load which may otherwise occur depending on the charging.

In this manner described above, when switch 4b is switched to the connected state, power supply from charger Ch is started, and thus, the power is supplied to connected batteries 2b to 2e that are connected to charger Ch. This increases storage amounts S of connected batteries 2b to 2e in accordance with a charging amount from charger Ch.

At this time, as in Embodiment 1, acquisition section 5 sequentially measures voltages of batteries 2a to 2e, and, based on the voltages measured by acquisition section 5, control section 6 connects unconnected battery 2a when a potential difference between connected batteries 2b to 2e and unconnected battery 2a falls within predetermined potential range R. This makes it possible to easily maximize charging amounts of batteries 2a to 2e while suppressing malfunction of charging control apparatus 3.

On the other hand, control section 6 maintains the current connected state when the potential difference between connected batteries 2b to 2e and unconnected battery 2a is out of predetermined potential range R.

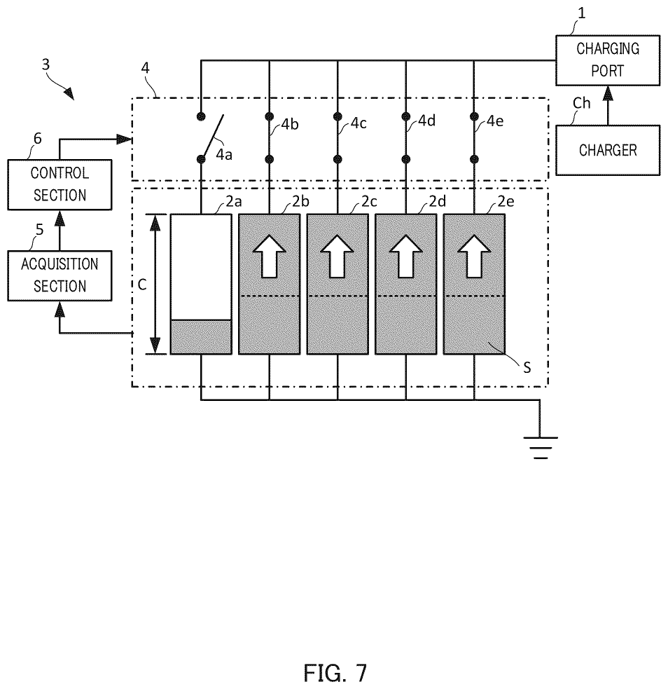

Thus, as illustrated in FIG. 7, storage amount S is increased to full capacities C of connected batteries 2b to 2e in accordance with the power supply from charger Ch. Here, at the start of charging, connecting not only reference batteries 2c to 2e but also battery 2b to charger Ch can easily maximize charging amounts of batteries 2a to 2e.

That is, it is possible to maximize the charging amount while suppressing the stop of the function of the load by connecting, to charger Ch, reference batteries 2c to 2e, which are connected to the load of the vehicle, and battery 2b whose potential difference with reference batteries 2c to 2e falls within predetermined potential range R, at the start of charging.

Incidentally, when battery 2a is further charged after completion of charging of batteries 2b to 2e, control section 6 can charge battery 2a by switching switches 4b to 4e to the disconnected states and switching switch 4a to the connected state.

According to the present embodiment, when charger Ch is connected, control section 6 controls connection section 4 such that reference batteries 2c to 2e, which are connected to the load of the vehicle, and battery 2b whose potential difference with reference batteries 2c to 2e falls within predetermined potential range R are connected to charger Ch. This makes it possible to increase a charging amount while suppressing the stop of the function of the load.

In Embodiments 1 and 2 described above, charging control apparatus 3 is mounted on an electric vehicle, but the present disclosure is not limited to this as long as a plurality of batteries 2a to 2e is connected in parallel. For example, charging control apparatus 3 can be mounted on an engine-driven vehicle.

Further, in Embodiments 1 and 2 described above, connection section 4 connects five batteries 2a to 2e in parallel, but the present disclosure is not limited to this as long as a plurality of batteries is connected in parallel.

Further, in Embodiments 1 and 2 described above, acquisition section 5 measures voltages of batteries 2a to 2e, but the present disclosure is not limited to a direct voltage-measurement as long as voltages can be acquired. For example, acquisition section 5 may acquire voltages based on current values of batteries 2a to 2e.

Further, in Embodiment 1 described above, control section 6 calculates storage amounts S of batteries 2a to 2e, but the present disclosure is not limited to this as long as reference battery 2a having the least storage amount S can be selected. For example, control section 6 may directly select reference battery 2a from the voltages measured by acquisition section 5.

Further, in Embodiments 1 and 2 described above, connection section 4 is composed of switches 4a to 4e, but the present disclosure is not limited to this as long as batteries 2a to 2e are connect to charger Ch in parallel.

The embodiments described above are merely examples of specific implementation of the present invention, and the technical scope of the present invention should not be restrictively interpreted by these embodiments. That is, the present invention may be implemented in various forms without departing from the spirit thereof or the major features thereof. For example, the disclosure of the shape, number, and the like regarding each part described in the above embodiments is merely an example, and may be implemented with appropriate modifications.

The present application is based on a Japanese Patent Application (Japanese Patent Application No. 2022-001630), filed on Jan. 7, 2022, the content of which is incorporated herein by reference.

### INDUSTRIAL APPLICABILITY

A charging control apparatus according to the present disclosure can be used for a control apparatus that controls a connection section that connects a plurality of batteries in parallel.

### REFERENCE SIGNS LIST

1 Charging port
2a to 2e Battery
3 Charging control apparatus
4 Connection section
4a, 4b Switch
5 Acquisition section
6 Control section
C Predetermined capacity
Ch Charger
R Predetermined potential range
S Storage amount

1. A charging control apparatus, comprising:
a connection section that connects a plurality of batteries in parallel to a charger connected to a vehicle;
an acquisition section that acquires voltages of the plurality of batteries; and
a control section that calculates, based on the voltages acquired by the acquisition section, a potential difference between a connected battery and an unconnected battery among the plurality of batteries and, in a case where the potential difference falls within a predetermined potential range, that controls the connection section such that the unconnected battery is connected to the charger, the connected battery being connected to the charger, the unconnected battery not being connected to the charger.

2. The charging control apparatus according to claim 1, wherein, when the charger is connected, the control section calculates potential differences between the plurality of batteries based on the voltages acquired by the acquisition section and that controls the connection section such that at least one of the plurality of batteries whose potential difference falls within the predetermined potential range is connected to the charger.

3. The charging control apparatus according to claim 2, wherein, when the charger is connected, the control section selects a reference battery having a least storage amount or a lowest voltage and that controls the connection section such that the reference battery and at least one of the plurality of batteries whose potential difference with the reference battery falls within the predetermined potential range are connected to the charger.

4. The charging control apparatus according to claim 2, wherein, when the charger is connected, the control section controls the connection section such that a reference battery and at least one of the plurality of batteries whose potential difference with the reference battery falls within the predetermined potential range are connected to the charger, the reference battery being connected to a load of a vehicle.
